(19) United States
(12) Patent Application Publication
(10) Pub. No.: US 2026/0129151 A1
(43) Pub. Date: May 7, 2026

(54) CHARACTERIZING VEILING GLARE-CORRECTED CROSSTALK FOR A THREE-DIMENSIONAL DISPLAY SYSTEM

(71) Applicant: GOOGLE LLC, Mountain View, CA (US)

(72) Inventors: Chia-Yang Shih, Mountain View, CA (US); John D. Perreault, Mountain View, CA (US); Brian R. Rankin, San Carlos, CA (US); Haiwei Chen, San Jose, CA (US)

(21) Appl. No.: 19/374,436

(22) Filed: Oct. 30, 2025

Related U.S. Application Data
(60) Provisional application No. 63/715,195, filed on Nov. 1, 2024.

(51) Int. Cl. H04N 13/125; H04N 13/305; H04N 17/00

(52) U.S. Cl. CPC H04N 13/125; H04N 13/305; H04N 17/00

(57) ABSTRACT

In at least one implementation, characterizing veiling glare-corrected crosstalk for a 3D display system is implemented by a method that includes identifying a first image of a display presenting an interleaved fringe pattern on the display. A non-interleaved gray code pattern is generated having the same period as the fringe pattern. A second image of the display presenting the gray code pattern on the display is identified. A more accurate intrinsic crosstalk for the display is determined based on the first image and the second image by correcting for veiling glare present in the optical measuring device.

### CROSS-REFERENCE TO RELATED APPLICATION

This application claims the benefit of U.S. Provisional Application No. 63/715,195, filed Nov. 1, 2024, the disclosure of which is incorporated herein by reference in its entirety.

### BACKGROUND

A three-dimensional (3D) display is a technology that visually presents three-dimensional imagery, creating a perception of depth for the viewer. The display can achieve this by presenting separate images to each eye through glasses (like stereoscopic systems that use polarized or shutter glasses) or glasses-free techniques (autostereoscopic displays) that rely on lenticular lenses or parallax barriers. These displays provide a sense of realism and immersion, commonly used in applications like gaming, virtual reality, medical visualization, and augmented reality.

### SUMMARY

This disclosure relates to systems and methods for characterizing veiling glare-corrected crosstalk for a 3D display system. In at least one implementation, characterizing veiling glare-corrected crosstalk for a 3D display system is implemented by a method that includes identifying a first image of a display presenting a fringe pattern on the display. The method also includes generating a gray code pattern having the same period as the fringe pattern. The method also includes identifying a second image of the display presenting the gray code pattern on the display. The method also includes determining an intrinsic crosstalk for the display based on the first image and the second image. In some aspects, the display is an autostereoscopic display. In some aspects, the fringe pattern is included in an interleaved image presented on the autostereoscopic display. In some aspects, the gray code pattern is included in a non-interleaved image presented on the autostereoscopic display.

In some aspects, determining a fringe period of the interleaved fringe pattern from the first image includes determining an orientation of the fringe pattern. Generating the gray code pattern having the same period as the fringe pattern includes generating the gray code pattern having a same orientation as the fringe pattern. In some aspects, the intrinsic crosstalk is determined based on a ratio of a first contrast of the first image to a second contrast of the second image.

In some aspects, the method further includes normalizing the first image and the second image using a full-black reference image and a full-bright reference image prior to determining the intrinsic crosstalk. In some aspects, the method further includes generating correction data based on the intrinsic crosstalk. The method also includes directing the display to render a third image based on the correction data.

The accompanying drawings and the description below outline the details of one or more implementations. Other features will be apparent from the description, drawings, and claims.

### BRIEF DESCRIPTION OF THE DRAWINGS

FIG. 1 illustrates an example autostereoscopic display system in accordance with at least one implementation.

FIG. 2 illustrates a system for characterizing veiling glare-corrected crosstalk for a 3D display system in accordance with at least one implementation.

FIG. 3A illustrates an example fringe pattern in accordance with at least one implementation.

FIG. 3B illustrates an example gray code pattern in accordance with at least one implementation.

FIG. 4 sets forth an example graph comparing crosstalk measurements with and without veiling glare correction.

FIG. 5 sets forth a flow chart of an example method for characterizing veiling glare-corrected crosstalk for a 3D display system in accordance with at least one implementation.

FIG. 6 sets forth a flow chart of another example method for characterizing veiling glare-corrected crosstalk for a 3D display system in accordance with at least one implementation.

FIG. 7 sets forth a flow chart of another example method for characterizing veiling glare-corrected crosstalk for a 3D display system in accordance with at least one implementation.

FIG. 8 sets forth a flow chart of another example method for characterizing veiling glare-corrected crosstalk for a 3D display system in accordance with at least one implementation.

FIG. 9 sets forth a flow chart of another example method for characterizing veiling glare-corrected crosstalk for a 3D display system in accordance with at least one implementation.

FIG. 10 illustrates an example computing environment for characterizing veiling glare-corrected crosstalk for a 3D display system in accordance with at least one implementation.

### DETAILED DESCRIPTION

A three-dimensional (3D) display is a device that visually presents imagery with a perception of depth, allowing a viewer to perceive visuals in three dimensions (height, width, and depth) rather than the two dimensions offered by conventional flat-panel screens. The ability of humans to perceive depth in the natural world is primarily due to binocular vision, or stereopsis. Because the human eyes are separated by a small distance, each eye captures a slightly different perspective of the same scene. The brain processes these two distinct two-dimensional images and fuses them into a single, three-dimensional perception, from which depth information is inferred.

Three-dimensional display technologies aim to replicate this natural process by delivering a separate, distinct image to each of the viewer's eyes. These images, referred to as a stereoscopic pair, are typically captured or rendered from two slightly different viewpoints corresponding to the positions of the left and right eyes. When presented correctly, the viewer's brain fuses this pair of images to perceive a 3D scene with a compelling sense of depth.

Some 3D display systems, known as stereoscopic displays, require the viewer to wear special glasses to ensure that each eye receives only its intended image. For example, active shutter glasses rapidly and alternately block the view of each eye in synchronization with a display that is alternating between showing the left-eye and right-eye images at a high frame rate. Another common approach uses passive polarized glasses, where the glasses have lenses with different polarization filters (e.g., circular or linear polarization). The display screen emits light for the left- and right-eye images with corresponding polarizations, and the glasses filter the light such that each eye only sees the image with the matching polarization.

While effective, the requirement of wearing glasses can be cumbersome for users. A different class of 3D displays, known as autostereoscopic displays, is capable of producing a 3D effect without the need for any special eyewear. These displays incorporate an optical element placed directly over the pixel grid of a standard display panel (e.g., a liquid crystal display or LCD) to direct the light from different sets of pixels into distinct spatial regions, or viewing zones.

Two common technologies used to achieve this directional light control in autostereoscopic displays are parallax barriers and lenticular lens arrays. A parallax barrier consists of an opaque layer with a series of precisely engineered vertical slits. This barrier is placed in front of the display's pixel array. The underlying image is rendered in an interleaved format, where columns of pixels corresponding to the left-eye image alternate with columns of pixels for the right-eye image. The parallax barrier is aligned such that from the perspective of the viewer's left eye, the slits reveal the columns of pixels displaying the left-eye image while blocking the columns displaying the right-eye image. Concurrently, from the perspective of the right eye, the barrier blocks the left-eye pixels and reveals the right-eye pixels. This creates two distinct viewing zones, one for each eye. When a viewer positions their head so that their eyes are in these respective zones, they perceive a 3D image.

A more advanced and commonly used technology is the lenticular lens array. This consists of a sheet of cylindrical lenses, or ‘lenticules,’ that is laminated onto the front of the display panel. Each lenticule is precisely aligned to span a small group of underlying pixel columns. Similar to the parallax barrier method, the image is rendered with interleaved columns for the left and right eye views. The curved surface of each lenticule acts as a miniature projector, refracting the light from the pixels beneath it in specific directions. For a simple two-view display, each lenticule might be aligned over a pair of pixel columns-one for the left view and one for the right view. The lenticule refracts the light from the left-view pixel column towards the left viewing zone and the light from the right-view pixel column towards the right viewing zone. Compared to parallax barriers, which work by blocking light, lenticular lenses are more light-efficient and typically produce a brighter 3D image.

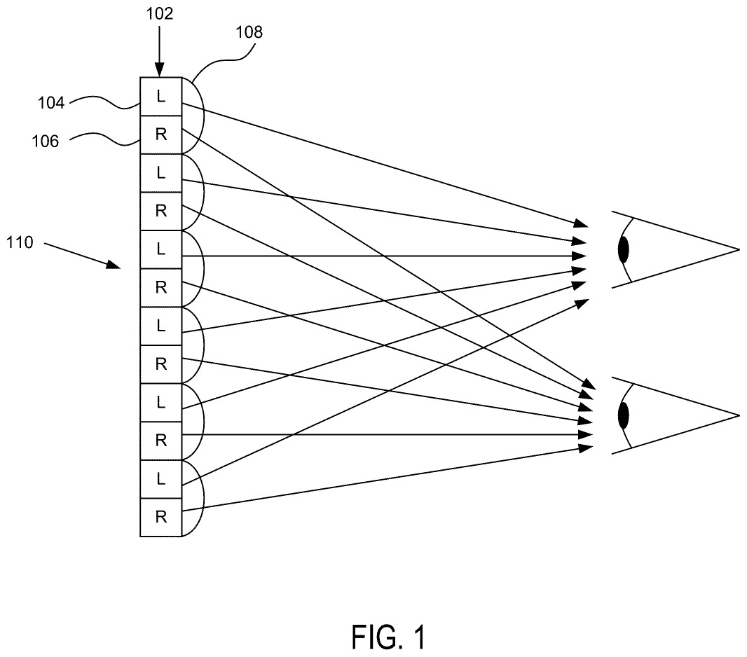

For further explanation, FIG. 1 sets forth a diagram of an example autostereoscopic display system that employs a lenticular lens sheet positioned over a flat panel display 110, such as a liquid crystal display (LCD) or organic light emitting diode (OLED) panel. The underlying display panel is typically composed of a pixel array 102, where each pixel includes multiple sub-pixels 104, 106 arranged in a regular grid. The lenticular lens array is aligned with the pixel grid such that each lens 108 optically distributes light from selected sub-pixels into different angular directions. By controlling which image data is rendered in which sub-pixels, multiple views of a scene can be interleaved across the panel. When observed through the lenticular lens array, the interleaved sub-pixel patterns are optically separated, and each eye of a viewer receives a different view of the scene. The human visual system combines the two views to perceive stereoscopic depth.

In some implementations, the mapping of views to sub-pixels is performed according to a periodic interleaving pattern, such as a square wave grating aligned to the lenticular pitch. For example, a given column of sub-pixels may correspond to a left-eye view, while an adjacent column corresponds to a right-eye view, with this pattern repeating across the display. More generally, in a multi-view configuration, successive sub-pixels may be assigned to different perspective images. The lenticular sheet directs the light emitted from each set of sub-pixels toward a corresponding angular zone, thereby establishing multiple viewing positions in front of the display.

Regardless of the specific optical technology used, a fundamental challenge in autostereoscopic displays is the imperfect separation of the left- and right-eye image channels. This phenomenon is known as crosstalk. Crosstalk occurs when a portion of the light intended for one eye leaks into the viewing zone of the other eye. For example, the right eye may perceive not only the complete right-eye image but also a faint, superimposed “ghost” of the left-eye image. This leakage degrades the quality of the stereoscopic effect by reducing the contrast and sharpness of the 3D image. High levels of crosstalk can diminish the sense of depth, cause visual artifacts such as double or ghosted edges, and lead to visual discomfort, eye strain, or even headaches for the viewer.

Crosstalk can originate from several sources. It may result from manufacturing tolerances, such as a slight misalignment between the lenticular lens array and the underlying pixel grid. Imperfections in the optical properties of the lenses or barriers, such as light scattering or diffraction, can also contribute. Furthermore, the viewing zones created by the optical elements are not perfectly discrete; there are transition regions between them where crosstalk is inherently higher. Therefore, even a perfectly manufactured display will exhibit increased crosstalk if the viewer is positioned outside the optimal viewing position. The performance of the underlying display panel itself, including factors like the pixel aperture ratio and internal light bleed between adjacent pixels, can also be a source of crosstalk. Given its significant impact on viewer experience, the accurate measurement and minimization of crosstalk are critical goals in the design, calibration, and manufacturing of high-quality autostereoscopic displays.

Intrinsic crosstalk refers to the optical leakage between adjacent viewing channels that is inherent to the physical structure and alignment of the display's components, such as the pixel array and the lenticular lens sheet, independent of common-mode illumination artifacts like veiling glare. To characterize intrinsic crosstalk, controlled test patterns are displayed on the panel and captured by a calibrated imaging system. The analysis determines how much light from bright regions of the pattern spreads into adjacent dark regions as viewed through the display's optical system. As used herein, a ‘fringe pattern’ is an interleaved three-dimensional test pattern for an autostereoscopic display. The fringe pattern includes a base pattern of alternating bright and dark regions, where the base pattern is either sinusoidal or binary (stripe-based), and where phase-shifted versions of the base pattern are spatially multiplexed at a pixel or sub-pixel level to correspond with distinct viewing zones of the display. In some examples, the fringe pattern includes alternating bright (e.g., green) and black stripes that are rendered in an interleaved format corresponding to the display's view multiplexing scheme to provide a 3D presentation of the fringe pattern. A viewing zone of the autostereoscopic display therefore receives an interleaved image based on two versions of the pattern that are spatially shifted according to the lenticular or barrier geometry.

For crosstalk characterization, some implementations use a camera positioned at a fixed location corresponding to one intended viewing zone of the display. The 3D fringe pattern is displayed and captured as a 2D image representing the light distribution perceived from that view. A patch can be selected from the captured image for image analysis. The patch is a contiguous region of the captured image that is used as a unit for the image analysis (for example, a 150-by-50 pixel patch). The image analysis determines an intensity distribution for the captured image. A characteristic of the fringe pattern within the patch is a fringe period. In the present disclosure, the fringe period is defined as the number of times the bright/dark pattern pair repeats within that patch, which can be referred to as a spatial frequency of the pattern pair. For example, if the patch contains a sequence of one green stripe followed by one black stripe repeated across the patch (i.e., green, black, green, black), the fringe period is the number of green/black pairs that occur within the patch. If the patch contains eight sets of green/black pairs across the patch, that is defined as a fringe period of 8 for that patch. Of note, intrinsic crosstalk characterization is affected by the period of the fringe pattern used to test the system. For example, different fringe patterns having different fringe periods (for example, period=2, 4, 8) may result in different crosstalk values.

To isolate optical leakage from electronic or offset effects, full bright and full black reference images are displayed and captured. For example, the reference images can be a full green image and a full black image. Image analysis determines the intensity distribution of the full-black reference image and the intensity distribution for the full-green reference image. The measured fringe intensity distribution is normalized using the reference image captures. This normalization compensates for nonzero black levels and brightness nonuniformities, ensuring that subsequent analysis reflects only the optical behavior of the display. In an ideal optical system, the captured fringe pattern would exhibit two distinct luminance levels corresponding to the bright (green) and dark (black) stripes. In practice, intrinsic crosstalk causes light from the bright regions to leak into the dark regions, thereby reducing overall contrast.

The degree of leakage is quantified by analyzing a luminance histogram or the average pixel intensities in the bright and dark regions within the patch to identify a maximum and minimum intensity. The maximum and minimum intensity are indicative of image contrast, and image contrast is indicative of crosstalk. A lower contrast or higher crosstalk ratio indicates greater spatial leakage within the display optics. The histogram shape in a luminance histogram also provides visual evidence of leakage: distinct, well-separated peaks correspond to high contrast and low crosstalk, whereas overlapping peaks indicate significant leakage.

The measured intrinsic crosstalk data are used to calibrate or correct the display's rendering pipeline. For example, a lookup table (LUT) mapping pixel or patch coordinates to measured crosstalk ratios can be generated and stored. During rendering, compensation values from the LUT are applied to adjust pixel intensities (or view weights) so that the perceived contrast and view separation at each patch are improved. In some implementations, the measured maps can also be used to inform mechanical or optical realignment of lenticular arrays or barriers during manufacturing.

Accurate characterization of intrinsic crosstalk is further complicated by the presence of veiling glare, such as optical scattering within the measurement device (e.g., an imaging camera) used to characterize the display. Veiling glare can include any incident light that reaches the measurement sensor, such as a high-resolution Basler camera, but is not originating from the display's intended view-specific projection. This glare is a common-mode signal, meaning it adds a non-view-specific intensity offset to both the desired view projection and the undesired crosstalk projection. This glare can originate from ambient light reflections off the display surface or internal light scatter within the display panel structure itself. If this offset is not accurately removed, the resulting calculated crosstalk percentage will be fundamentally inaccurate.

To precisely isolate and quantify this veiling glare, a standard test pattern is typically utilized. A checkerboard (or chessboard) pattern can be employed to define and sample the display's absolute zero-output state (black level). A high-contrast checkerboard image is displayed, where adjacent groups of pixels are alternating between a maximum output (white) and a minimum output (black). During this measurement, the camera is focused on the pixels that are commanded to the black (off) state. Since these pixels are commanded to render a true black, the intended output light from those specific areas is zero. Therefore, any residual light intensity detected by the camera in these black regions is attributed entirely to the veiling glare and system noise. The checkerboard pattern thus serves as a robust method to spatially sample and isolate this constant glare component. This measured glare intensity is then subtracted from all subsequent view-specific calibration measurements. By accurately eliminating the veiling glare component common to both view projections, this step ensures that the final calculated crosstalk value accurately reflects only the actual optical separation capability of the autostereoscopic display system.

Crosstalk may be evaluated using a variety of fringe patterns with different periods. As the period of the fringe pattern changes, the amount of crosstalk present in the image changes due to the changing amount of veiling glare. The change in crosstalk with a change in fringe period is a measurement artifact that can be caused by veiling glare. A single, static chessboard pattern fails to account for these variations. Applying a correction factor derived from one static chessboard pattern to different fringe patterns leads to inconsistent and inaccurate results. For example, the calculated intrinsic crosstalk value can appear to change significantly depending on the fringe pattern used to determine the crosstalk value, not because the display's actual crosstalk is changing, but because the veiling glare correction is mismatched. This inconsistency makes it difficult to reliably calibrate the display. Thus, intrinsic crosstalk characterization is affected by the period of the fringe pattern used to test the system. For example, different fringe patterns having different fringe periods may result in different crosstalk values because the amount of veiling glare present in an image can strongly depend on the distance scales between light and dark regions of the image

To address the deficiencies of conventional veiling glare correction methods, a system and method are provided that dynamically adapt the glare correction based on the spatial characteristics of the test pattern being measured. Instead of using a static chessboard pattern, the veiling glare correction is based on a gray code pattern that is generated to have the same spatial period as the fringe pattern under test. By ensuring the correction pattern has the same spatial frequency as the test pattern, a more accurate and consistent veiling glare subtraction is achieved, leading to a more reliable measurement of the display's true intrinsic crosstalk. This approach ensures that the correction is always matched to the test conditions, eliminating the variability and inaccuracy that arise from using a single, mismatched chessboard pattern for all fringe periods. As used herein, a gray code pattern is a non-interleaved two-dimensional test pattern image that includes alternating bright and dark stripes.

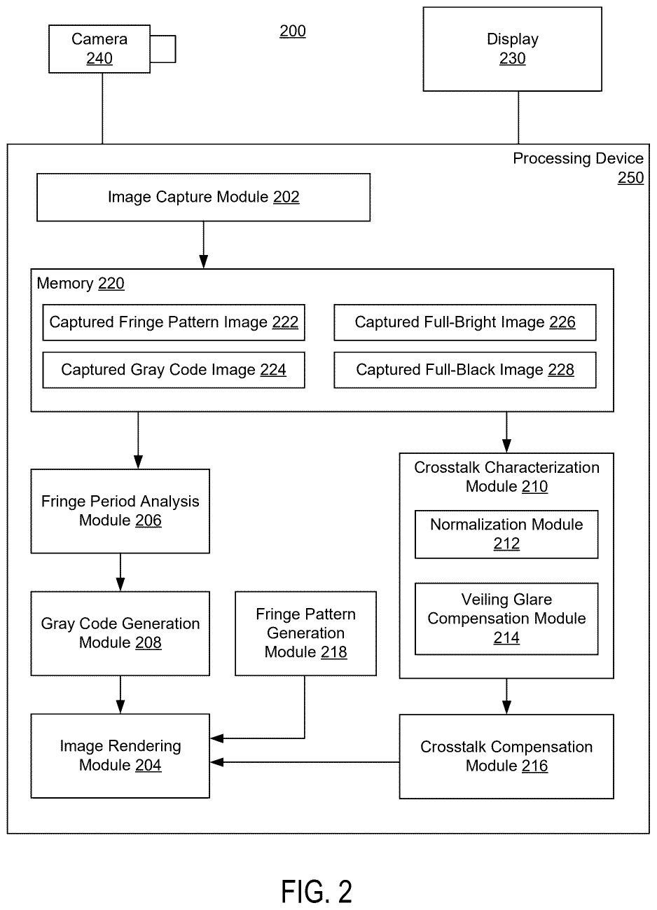

For further explanation, FIG. 2 sets forth a block diagram of an example system 200 for characterizing veiling glare-corrected crosstalk for a 3D display system in accordance with at least one embodiment of the present disclosure. In some implementations, the system 200 includes an image processing device, 250, camera 240, a display 230, such as an autostereoscopic display or other 3D display. In some examples, the image processing device includes at least one processor that is configured to execute a crosstalk analysis program, which can include a variety of modules to facilitate an intrinsic crosstalk measurement, as explained below.

In some implementations, the image analysis device 250 includes a fringe pattern generation module 218. The fringe pattern generation module 218 is configured to generate an interleaved three-dimensional (3D) fringe pattern suitable for display on an autostereoscopic panel. The module produces a pattern in which sinusoidal or stripe-based fringes corresponding to left eye and right eye view channels are spatially interleaved according to the display's optical geometry, such as the pixel mapping defined by a lenticular lens array or a parallax barrier. For example, a sinusoidal fringe pattern can be rendered for the left-eye view, while an inverted or phase-shifted version of the same pattern is rendered for the right-eye view. The fringe pattern includes alternating bright and dark stripes or sinusoids. For example, the bright stripe can correspond to a specific color channel. The green color channel is used as an example throughout this disclosure; however, it will be appreciated that red or blue color channels can also be used.

In some examples, the fringe pattern generation module 218 receives as input a set of parameters defining the display geometry, including the number of views N, the sub-pixel pitch, the lens or barrier pitch, and the viewing geometry (e.g., lens slant angle and focal distance). From these parameters, the module determines a view assignment map that specifies, for each pixel position (x, y) on the panel, which view or channel that pixel contributes to when observed through the optical element. In some examples, this mapping can define an interleaving pattern that enables a multi-view presentation.

In some examples, the fringe pattern generation module 218 generates a base fringe pattern, which may be either binary or sinusoidal. To create an interleaved 3D fringe pattern, the module generates a distinct fringe phase φv for each view v (for example, φv=2π*v/N). Each pixel is then assigned an intensity value from the fringe function corresponding to the phase of the view to which that pixel belongs according to the view assignment map. As a result, the final image encodes multiple phase-shifted fringe patterns across the display surface, one per view, distributed in an interleaved fashion at the sub-pixel level. In another example, the module generates the interleaved pattern by first creating N independent 2D fringe images, each representing the fringe pattern for a single view, and then multiplexing these images into a single composite frame according to the view assignment map. This approach facilitates flexible control of each view's phase, amplitude, or color channel. The resulting interleaved pattern appears as a 3D fringe image when viewed on an autostereoscopic display. Each viewing direction isolates one of the phase-shifted component fringes, enabling precise measurement of optical leakage between adjacent views when the display is imaged by a camera positioned at different viewing zones.

In some implementations, the image analysis device 250 includes a display rendering module 204. The display rendering module 204 renders the generated fringe pattern and other frames on the autostereoscopic display 230. Rendering to an autostereoscopic display may require precise timing, as the perceived image depends on the synchronization between the projected image and the viewer's position. The display rendering module 204 ensures the composite image is rendered at the display's specific refresh rate to maintain stable 3D visualization. The final synthesized image data, whether containing the 3D fringe patterns, reference images, or other images is passed to the display's driver via a standard graphics pipeline interface (e.g., a graphics card API) for physical display. The autostereoscopic hardware then uses its optical elements to direct the different interleaved patterns into separate left eye and right eye views based on the pixel geometry.

In some examples, the display rendering module 204 also renders uniform reference frames. A full bright frame is rendered by synthesizing an image where every interleaved view displays the full-bright uniform reference image (e.g., full green). This image can be used for determining the maximum achievable intensity and for calibrating the system's ambient light or projector output. A full black frame is rendered by synthesizing an image where every interleaved view displays the full-black pattern. This frame can be used for determining the minimum intensity and for calculating the contrast modulation of the system.

In some implementations, the image analysis device 250 includes camera capture module 202 configured to interface with the camera 240 that is positioned to observe the display 230. The camera 240 may be communicatively coupled to the image analysis device 250 through a wired or wireless communications interface, including, for example, a Universal Serial Bus (USB) link or a wireless protocol such as Wi-Fi or Bluetooth. In some examples, the camera capture module 202 is operative to receive, in real time or batch mode, one or more digital images captured by the camera during display of calibration patterns, such as an interleaved fringe pattern, a full-black frame, or a full-green frame.

Upon receipt, the camera capture module stores the captured image data in a memory 220 for subsequent processing by other functional modules of the system. For example, the memory 220 may store a captured fringe pattern image 222 that is a camera capture of the fringe pattern image presented on the display 230, a captured full-bright image 226 that is a camera capture of a full-bright frame presented on the display 230, and a captured full-black image 228 that is a camera capture of a full-black frame presented on the display 230. In various examples, the image data may be stored in a standardized digital format such as raw Bayer data, RGB images, or grayscale intensity matrices, depending on the configuration of the camera and the requirements of downstream processing. In some examples, the camera capture module 202 further provides active control of the camera 240 by, for example, transmitting command signals to the camera 240 over the communications interface to initiate or terminate image capture sequences, adjust exposure parameters, gain, or white balance, or synchronize image capture with the display of specific test patterns.

In some implementations, the system 200 includes a fringe period analysis module 206 configured to determine a period of the fringe pattern in the fringe pattern image. The fringe period analysis module 206 receives the digital image of a fringe pattern captured by a camera. In some implementations, the fringe pattern image is cropped to a fixed-size patch (e.g., 50×50 pixels) that undergoes one or more pre-processing steps. In some examples, the pre-processing includes isolating the color channel corresponding to the displayed color (for example, the green channel), subtracting the black-level image to remove background illumination and sensor bias, and/or normalizing the resulting intensity values to a consistent range such as 0 to 1. Further, the pre-processing can include converting the image into a single-channel grayscale intensity map to simplify computations. A noise reduction filter, such as a median or Gaussian filter, may also be applied to smooth high-frequency noise and improve the signal-to-noise ratio of the subsequent analysis.

In some implementations, to determine the periodicity of the fringes, the module transforms the two-dimensional image data into a one-dimensional intensity profile. This can be achieved by analyzing the image to determine the principal orientation of the fringe stripes. Once the orientation is known, an intensity profile is generated by averaging pixel intensities along an axis parallel to the fringes, effectively capturing the intensity variation in the direction perpendicular to the stripes.

In some implementations, the image analysis includes analysis in the frequency domain. In one example, a Fast Fourier Transform (FFT) is applied to the one-dimensional intensity profile or, alternatively, a two-dimensional FFT is applied to the pre-processed image. A repeating pattern in the spatial domain, such as the alternating bright and dark stripes of a fringe pattern, will manifest as distinct, high-energy peaks in the frequency domain. The distance of these peaks from the central DC component is directly proportional to the spatial frequency of the fringe pattern. The spatial period, which represents the width of one complete bright-and-dark cycle, is the inverse of this spatial frequency. By locating the position of these peaks, the module can precisely calculate the period of the fringe pattern. In some implementations, an autocorrelation analysis is used to determine the fringe period by identifying the lag at which the autocorrelation function first reaches a maximum, which corresponds to the repetition distance of the sinusoidal pattern.

In some implementations, the period is determined by analyzing the intensity profile in the spatial domain. This may involve identifying local maxima and minima corresponding to the centers of the bright and dark stripes. The period is then calculated by counting the number of complete bright-and-dark sequences across the profile. The final period value can be calculated as a fractional number by dividing the total patch length by the average measured sequence length to account for partial sequences.

Furthermore, the angular position of the peaks in a 2D frequency-domain analysis can provide the orientation, or tilt angle, of the fringes in the original image. The fringe period analysis module can therefore determine not only the period but also the angle of the fringes, allowing for more accurate matching of the corresponding correction pattern. The output of the module is a numerical value representing the determined number of periods, which is then used by the system 200 to select or generate a gray code pattern that has the same number of periods and, optionally, the same tilt angle.

In some implementations, the system 200 includes a gray code generation module 208. The gray code generation module 208 renders a 2D gray code pattern image that includes a gray code period having the same period as the fringe period determined by the fringe period analysis module 206. In some implementations, the gray code generation module 208 generates a gray code pattern having the same period as the fringe pattern by generating a binary pattern of alternating bright and dark stripes. For example, the bright stripes can be the same color channel as the fringe pattern. The number of these stripes are selected such that the period (e.g., spatial frequency) of the resulting gray code matches that of the fringe pattern. For example, if the analysis module determines the fringe pattern has six periods within a given patch, the gray code generation module 208 creates a gray code pattern with six corresponding bright/dark cycles. This ensures that the veiling glare characteristics of the correction pattern closely approximate those of the test pattern, leading to a more accurate subtraction and a more reliable crosstalk measurement.

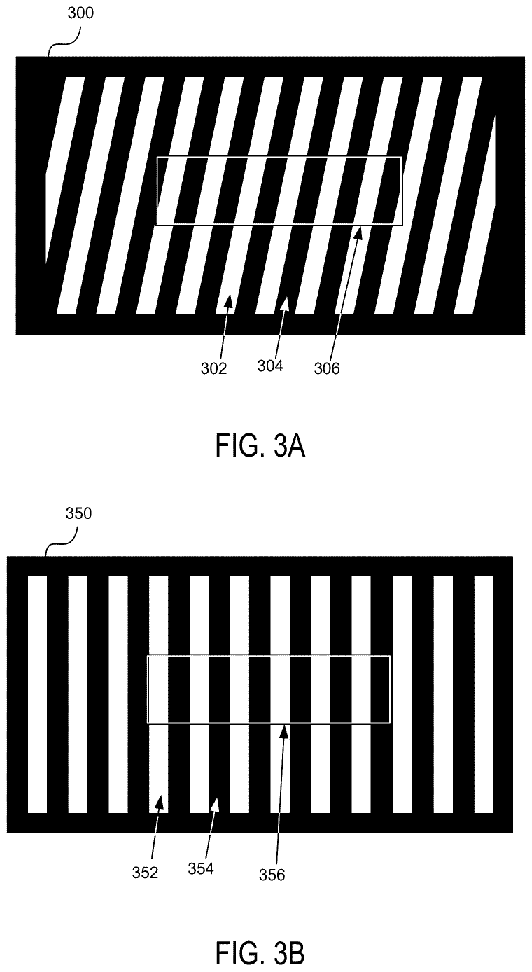

An example fringe pattern 300 is shown in FIG. 3A. The fringe pattern 300 includes bright portions 302 and dark portions 304. In illustrative example, the bright portions 302 may be green and the dark portions 304 may be black. The image may be cropped to a patch 306 have a predetermined patch size. FIG. 3B sets forth an example gray code pattern 350 having the same period as the fringe pattern 300 is shown in FIG. 3B. The example gray code pattern includes bright portions 352 and dark portions 354. The bright portions 352 may be the same color as the bright portions 302 of the fringe pattern 300, and the dark portions 354 can also be black. In FIGS. 3A and 3B, the example fringe pattern 300 and example gray code pattern 350 both have a period of six within the respective patches 306, 356.

The orientation of the generated gray code pattern is not limited to vertical or horizontal stripes. The gray code generation module 208 can be configured to generate stripes at any orientation to match the fringe pattern being analyzed. For example, the gray code pattern can be rendered as vertical stripes, horizontal stripes, or stripes tilted at a specific angle that corresponds to the tilt angle of the fringes, as determined by the image analysis module. This ensures that the veiling glare correction pattern's orientation aligns with the test pattern, further improving the accuracy of the crosstalk measurement, particularly when dealing with fringe patterns that are not perfectly aligned with the display's primary axes.

In some implementations, the 2D gray code pattern frame is rendered on the display 230 by the display rendering module 204. For example, the 2D gray code image passed to the display's driver via a standard graphics pipeline interface (e.g., a graphics card API) for physical display. In some implementations, the camera capture module 202 obtains an image of the gray code pattern displayed on the display 230 and stores the captured gray code image 224 in the memory 220.

The system 200 also includes a crosstalk characterization module 210 configured to determine an intrinsic crosstalk for the display. In some implementations, the crosstalk characterization module 210 includes a normalization module 212 configured to compensate for nonidealities in the captured images of the display prior to crosstalk characterization. In practice, when an image of the display is captured, neither the display nor the imaging sensor produces perfectly zero intensity when displaying a nominally black image. Factors such as panel leakage, ambient reflection, backlight nonuniformity, and camera dark current can introduce a residual baseline intensity that is unrelated to the displayed pattern. If this residual component is not removed, it can distort the measured contrast and lead to inaccurate estimation of modulation and crosstalk.

The normalization module 212 utilizes the full-black image 228 and the full-bright image 226 (uniform luminance) as reference images to compensate for this effect. The full-black image represents the display's residual luminance or leakage level when no signal is applied. The full-bright image represents the maximum achievable luminance under uniform drive. The normalization module 212 pre-processes the full-black reference image to identify an intensity distribution in the image, denoted as I_black(x, y). Further, the normalization module 212 pre-processes the full-bright (uniform luminance) reference image to identify an intensity distribution in the image. As an illustrative example, consider that the full-bright reference image. In this case, the identified intensity distribution is denoted as Igreen(x, y).

For the captured fringe pattern image 222, the intensity distribution I_fringe(x, y) includes both the desired modulated component of the displayed pattern and the undesired baseline offset contributed by black-level leakage. For each pixel location (x, y), the module first subtracts the corresponding intensity of the full-black image from the captured fringe image to remove the additive baseline. The black-level subtraction is applied as:

$$I\_fringe \_corrected ( x , y ) = I\_fringe ( x , y ) - I\_black ( x , y ) .$$

The full-green image is similarly corrected by subtracting the same black-level reference. To normalize the fringe pattern intensity distribution, black-level subtraction should also be applied to the full-green reference image, as follows:

$$I\_green \_corrected ( x , y ) = I\_green ( x , y ) - I\_black ( x , y ) .$$

The corrected full-green image thus represents the maximum achievable luminance of the display, independent of any dark-level offset. The corrected fringe pattern image can then be normalized by dividing by the corrected full-green image to scale all intensities into a consistent range between 0 and 1, as follows:

$$I\_fringe \_norm ( x , y ) = I\_fringe \_corrected ( x , y ) / I\_green \_corrected ( x , y ) .$$

This operation produces a normalized fringe pattern image in which all intensities are expressed as relative luminance values between zero and one, effectively compensating for both spatial luminance variation and display-to-camera gain differences.

Similarly, an intensity distribution of the captured gray code image 224, denoted I_graycode(x,y), is determined through image processing. For each pixel location (x, y) in the graycode intensity distribution, the image normalization submodule subtracts the corresponding intensity of the full-black image from the captured fringe image to remove the additive baseline. Black-level subtraction can be applied as:

$$I\_graycode \_corrected ( x , y ) = I\_graycode ( x , y ) - I\_black ( x , y ) .$$

The corrected gray code image can then be normalized by dividing by the corrected full-green image to scale all intensities into a consistent range between 0 and 1, as follows:

$$I\_graycode \_norm ( x , y ) = I\_graycode \_corrected ( x , y ) / I\_green \_corrected ( x , y ) .$$

This operation produces a normalized gray code image in which all intensities are expressed as relative luminance values between zero and one.

The crosstalk characterization module 210 also includes a veiling glare compensation module 214. The veiling glare compensation module 214 is configured to determine the intrinsic crosstalk of the display based on intensity contrast derived from the normalized fringe pattern image and compensate for veiling glare using an intensity contrast derived from the normalized gray code image. The normalized fringe pattern image and the normalized gray code image, obtained from the image normalization module, represent the true luminance variation of the captured fringe pattern and gray code image after correction for black-level offset and luminance nonuniformity. The veiling glare compensation module 214 evaluates the degree to which the bright and dark regions of the displayed pattern have blended together as a result of optical leakage between left and right eye views, and subtracts out a veiling glare contribution to the characterized leakage.

In some implementations, the veiling glare compensation module 214 computes a luminance histogram for the normalized fringe pattern image to represent the frequency distribution of intensity values. In an ideal display condition with no crosstalk, the histogram would exhibit two distinct and well-separated peaks: one corresponding to the bright (high-luminance) portions of the fringe pattern and the other corresponding to the dark (low-luminance) portions. Crosstalk causes these peaks to move closer together, reducing the overall modulation contrast of the captured pattern. To characterize crosstalk in the fringe pattern image, the veiling glare compensation module 214 identifies the local maxima in the histogram corresponding to the bright and dark intensity clusters and computes their mean intensity values, denoted I_max and I_min, respectively. These values are used to calculate the measured contrast of in the fringe pattern image, denoted as C_fringe, according to:

$$C\_fringe = ( I\_max - I\_min ) / ( I\_max + I\_min ) .$$

To characterize veiling glare contribution, the veiling glare compensation module 214 computes a luminance histogram for the normalized gray code image to represent the frequency distribution of intensity values. Like the analysis of the fringe pattern image, the veiling glare compensation module 214 identifies the local maxima in the histogram corresponding to the bright and dark intensity clusters of the gray code image and computes their mean intensity values, denoted I_max and I_min, respectively. These values are used to calculate the measured contrast of in the gray code image, denoted as C_graycode, according to:

$$C\_graycode = ( I\_max - I\_min ) / ( I\_max + I\_min ) .$$

The contrast C_fringe and the contrast C_graycode both include the same veiling glare contribution based on the same period. Thus, the veiling glare contribution can be eliminated by dividing the measured contrast of the fringe pattern image by the measured contrast of the gray code image to obtain a corrected contrast C_corrected, as follows:

$$C\_corrected = C\_fringe / C\_graycode .$$

The corrected intrinsic crosstalk, denoted CT_corrected, is thus characterized by the inverse of the corrected contrast divided by two, as follows:

$$CT\_corrected = ( 1 - C\_corrected ) / 2.$$

By using the corrected_contrast (the contrast value after veiling glare has been subtracted out), this calculation gives the corrected crosstalk, which is the true intrinsic crosstalk of the display itself.

In some implementations, the system 200 includes a crosstalk compensation module 216 configured to generate correction data used to reduce optical leakage between left-eye and right-eye image channels in an autostereoscopic display system. The crosstalk compensation module 216 pre-compensates for the known optical leakage, thereby minimizing the crosstalk perceived by the viewer and enhancing the quality and comfort of the 3D experience. The compensation module receives, as input, the corrected crosstalk values determined from the measurement process described above. In some embodiments, this input may be a single global crosstalk value. In other, more advanced embodiments, the input is a spatial crosstalk map, which provides distinct crosstalk values for different regions or calibration patches across the display, or across different views. This allows for localized compensation that can address variations in optical performance across the display panel.

Based on the input crosstalk data, the crosstalk compensation module 216 generates a correction function. In some examples, the crosstalk compensation module computes a pair of correction coefficients that describe how the left-eye and right-eye intensity signals should be adjusted to counteract the measured leakage. Various implementations can include a multi-dimensional lookup table (LUT) or an inverse crosstalk matrix as the correction function. In some examples, the crosstalk compensation module 216 models the light leakage by establishing a mathematical relationship between the intended pixel intensities for each view and the actual light distribution measured in the viewing zones. For example, a crosstalk matrix can be formulated that describes how a percentage of light from a pixel intended for the left-eye view leaks into the right-eye view, and vice versa. The crosstalk compensation module 216 then computes the inverse of this function or matrix. This inverse function represents the necessary pre-distortion that must be applied to the source image data to counteract the physical crosstalk of the display. The output of the compensation module can be, for example, an LUT that maps input pixel intensity values to corrected output values. This calibration file is then loaded into the display's rendering pipeline or image processor.

When a 3D image is to be displayed, the rendering engine can use the LUT to adjust the intensity of each pixel for the original left- and right-eye image. For instance, to compensate for light leaking from a bright pixel in the left-eye image into a dark area of the right-eye image, the module might slightly reduce the intensity of the bright pixel in the left-eye image. By applying these calculated adjustments across the entire image, the system effectively pre-emptively cancels out the optical leakage. The resulting image displayed on the panel is intentionally distorted in such a way that, after passing through the display's optical system (e.g., the lenticular lens array), the light reaching the viewer's eyes is corrected, and the perceived crosstalk is significantly reduced without overcompensating because of veiling glare.

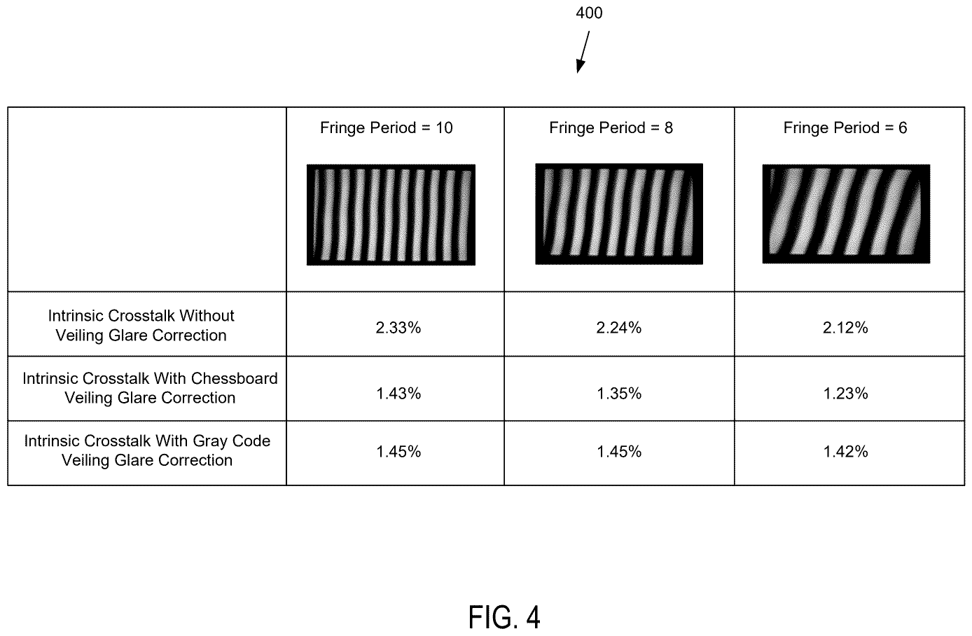

For further explanation, FIG. 4 illustrates a table 400 illustrating the effects of veiling glare correction on crosstalk characterization through different methodologies. For different fringe images having different fringe periods, the table 400 illustrates the measured crosstalk for each fringe pattern without using veiling glare correction, the measured crosstalk for each fringe pattern image using a chessboard pattern for veiling glare correction, and the measured crosstalk for each fringe pattern using a gray code pattern for veiling glare correction in accordance with the present disclosure. As can be seen in table 400, the measured crosstalk using a chessboard pattern for veiling glare correction varies based on the fringe period, while the measured crosstalk using a gray code pattern for veiling glare correction is substantially consistent across the different fringe patterns.

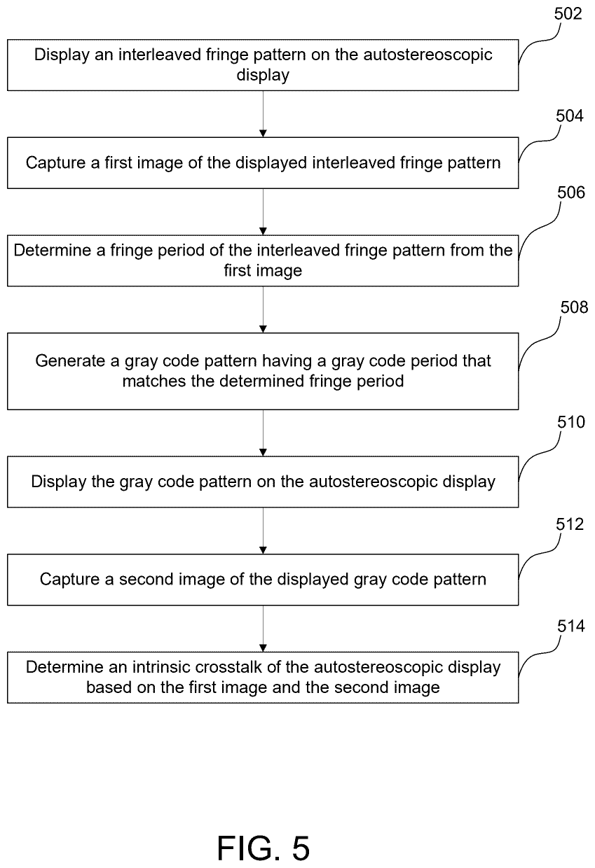

For further explanation. FIG. 5 sets forth flow chart of an example method for crosstalk characterization and veiling glare compensation in accordance with at least one embodiment of the present disclosure. The method of FIG. 5 includes displaying an interleaved fringe pattern on the autostereoscopic display at block 502. In some examples, a fringe pattern is an interleaved three-dimensional test pattern for an autostereoscopic display, the fringe pattern comprising a base pattern of alternating bright and dark regions, wherein the base pattern is either sinusoidal or binary (stripe-based), and wherein phase-shifted versions of the base pattern are spatially multiplexed at a sub-pixel level to correspond with distinct viewing zones (e.g., left eye and right eye viewing zones) of the display. In some examples, the fringe pattern includes alternating bright (e.g., green) and black stripes that are rendered in an interleaved format corresponding to the display's view multiplexing scheme to provide a 3D presentation of the fringe pattern. A viewing zone of the autostereoscopic display therefore receives an interleaved image based on two versions of the pattern that are spatially shifted according to the lenticular or barrier geometry.

The method includes capturing a first image of the displayed interleaved fringe pattern at block 504. A camera, aligned with a specific viewing zone (e.g., the left-eye view), captures a digital image of the fringe pattern presented on the display. The captured image represents the optical output of the display as perceived from that viewing direction, including both the desired pattern and any artifacts like crosstalk and veiling glare.

The method includes determining a fringe period of the interleaved fringe pattern from the first image at block 506. The captured fringe pattern image is processed to determine its spatial period. In some implementations, this is accomplished by applying a Fast Fourier Transform (FFT) to a patch of the image. The repeating fringe pattern produces distinct peaks in the frequency domain, and the position of these peaks is used to calculate the spatial frequency and, consequently, the period of the fringes. This step can also determine the orientation or tilt angle of the fringes.

The method includes generating a gray code pattern having a gray code period that matches the determined fringe period at block 508. For example, the gray code pattern is a 2D, non-interleaved image that includes alternating bright and dark stripes with a spatial period that matches that of the fringe pattern analyzed in the previous step. This matching ensures that the veiling glare produced by the gray code pattern will be representative of the glare present in the fringe pattern measurement.

The method includes displaying the 2D gray code pattern on the autostereoscopic display at block 510. The method also includes capturing a second image of the displayed 2D gray code pattern at block 512. The second image is captured by the camera from the same position and provides a baseline measurement of the display and camera system's response to a pattern with the same spatial frequency as the fringe pattern but without the interleaved 3D component.

The method includes determining an intrinsic crosstalk of the autostereoscopic display based on the first image and the second image at block 514. Intrinsic crosstalk refers to the portion of a light signal from a first viewing channel that is optically coupled into a second, adjacent viewing channel due to the inherent properties of the display's view-separating optical element. In some implementations, to determine the intrinsic crosstalk, both the fringe image and the gray code image are normalized using captured images of full-black and full-bright reference images to compensate for display non-uniformities and black-level offsets. A contrast value is calculated for each of the normalized images. Because the gray code pattern isolates the veiling glare contribution for that specific spatial frequency, the measured fringe contrast is corrected by dividing it by the gray code contrast. This operation effectively removes the veiling glare component from the fringe measurement. The resulting corrected contrast value is then used to calculate the actual intrinsic crosstalk of the display, free from the inaccuracies introduced by veiling glare.

It will be appreciated that, in various implementations, the method of FIG. 5 can be repeated for multiple views, including a left eye view, a right eye view, different viewing orientations relative to the display (e.g., normal to the display and off-axis), and so forth. In such implementations, a characterization of crosstalk in the display can be determined for each of the different views. It will be further appreciated that, in various implementations, the method of FIG. 5 can be repeated using different fringe patterns. For example, the different fringe patterns can include different fringe periods, different fringe shapes, different color channels for the bright portions of the fringe pattern, and so forth. In such implementations, a characterization of crosstalk in the display can be determined for each fringe pattern.

The method of FIG. 5 provides significant technical advantages over conventional approaches to display calibration. By dynamically generating a veiling glare correction pattern that is spatially matched to the fringe pattern under test, the method overcomes the technical problem of inconsistent and inaccurate crosstalk measurements that arise from using a static, mismatched correction pattern. This adaptive approach yields a more accurate and repeatable characterization of a display's actual intrinsic crosstalk, regardless of the test pattern's specific period or orientation. The tangible result is a more reliable calibration process and an improved autostereoscopic display that exhibits reduced visual artifacts and delivers a higher-quality, more comfortable three-dimensional viewing experience for the user.

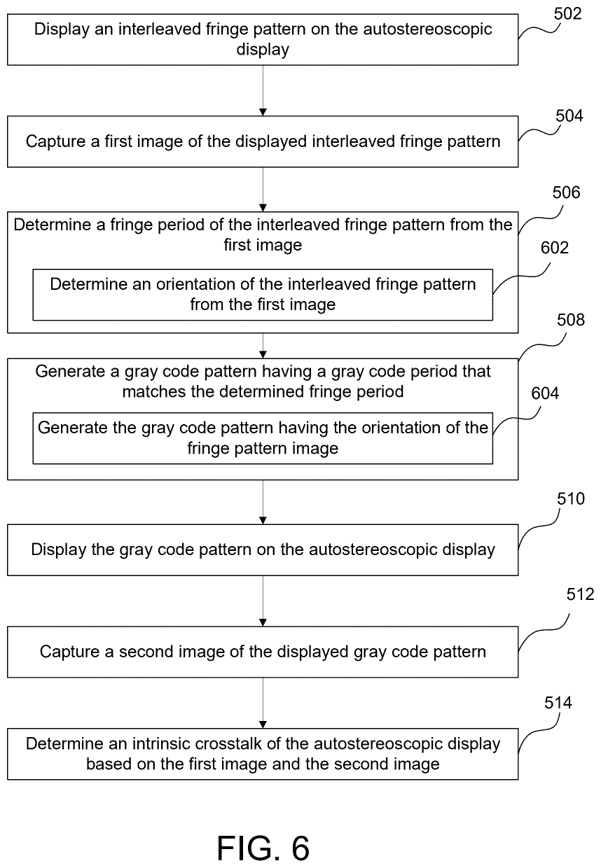

FIG. 6 is a flow chart illustrating another example method for characterizing veiling glare-corrected crosstalk for a 3D display system in accordance with at least one embodiment of the present disclosure. The example method of FIG. 6 extends the method described in FIG. 5. In the example of FIG. 6, characterizing the crosstalk includes orientation matching between the fringe pattern and the gray code pattern. In the example of FIG. 6, determining a fringe period of the interleaved fringe pattern from the first image at block 506 includes determining a fringe orientation of the interleaved fringe pattern from the first image at block 602. This is often done by analyzing the angular position of peaks in the frequency domain after an FFT. In the method of FIG. 6, generating a gray code pattern having a gray code period that matches the determined fringe period at block 508 includes generating the 2D gray code pattern to have a gray code orientation that matches the determined fringe orientation at block 604. The 2D gray code pattern is generated to match not only the period but also the orientation of the fringe pattern. By aligning the orientation of the gray code pattern with the fringe pattern, the veiling glare measurement more accurately reflects the glare conditions of the original test, improving the final crosstalk characterization.

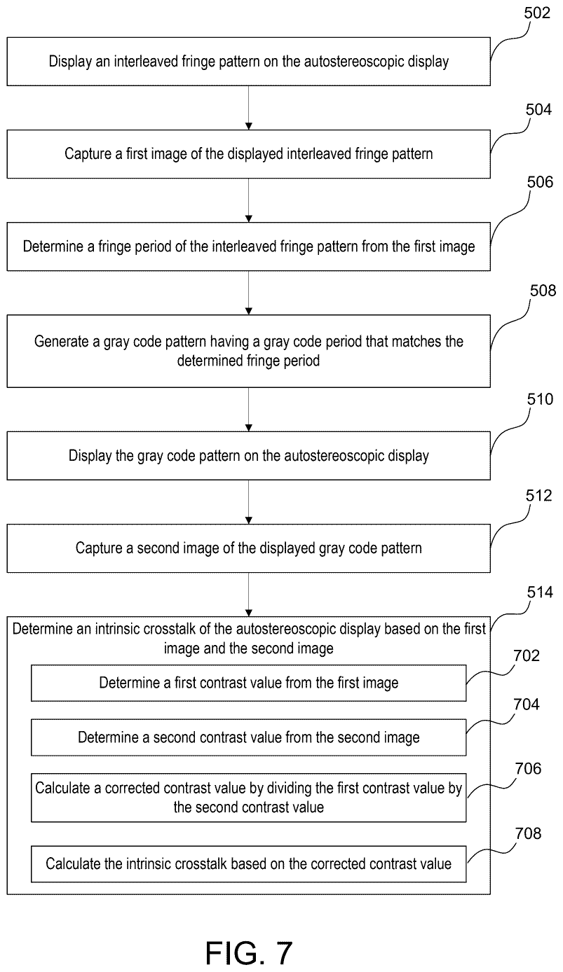

FIG. 7 is a flow chart illustrating another example method for characterizing veiling glare-corrected crosstalk for a 3D display system in accordance with at least one embodiment of the present disclosure. The example method of FIG. 7 extends the method described in FIG. 5 by detailing the characterization of intrinsic crosstalk at block 514. In the example of FIG. 7, a first contrast value is calculated from the first image (the captured fringe pattern) at block 702. This is typically done by finding the mean intensities of the bright and dark regions in the image and applying the standard contrast formula. At block 704, a second contrast value is calculated from the second image (the captured gray code pattern) using the same method. At block 706, a corrected contrast value is calculated by dividing the first contrast value by the second. This operation effectively removes the veiling glare component common to both measurements. At block 708, the intrinsic crosstalk is calculated based on this corrected contrast value, yielding a more accurate measurement of the display's true optical leakage.

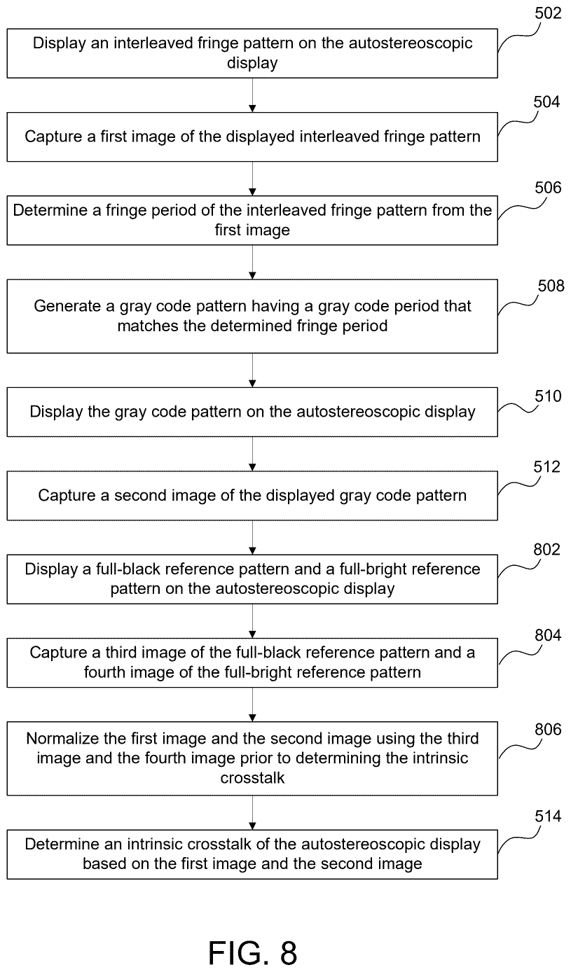

FIG. 8 is a flow chart illustrating another example method for characterizing veiling glare-corrected crosstalk for a 3D display system in accordance with at least one embodiment of the present disclosure. The example method of FIG. 8 extends the method described in FIG. 5 by incorporating reference image captures to improve measurement accuracy. The method of FIG. 8 includes displaying a full-black reference pattern and a full-bright reference pattern on the autostereoscopic display at block 802. The method includes capturing a third image of the full-black reference pattern and a fourth image of the full-bright reference pattern at block 804. The method also includes normalizing the first image and the second image using the third image and the fourth image prior to determining the intrinsic crosstalk at block 806. This normalization subtracts the black-level offset and scales the intensities relative to the display's maximum brightness, compensating for panel non-uniformities and ensuring the final crosstalk calculation is based purely on the display's optical performance.

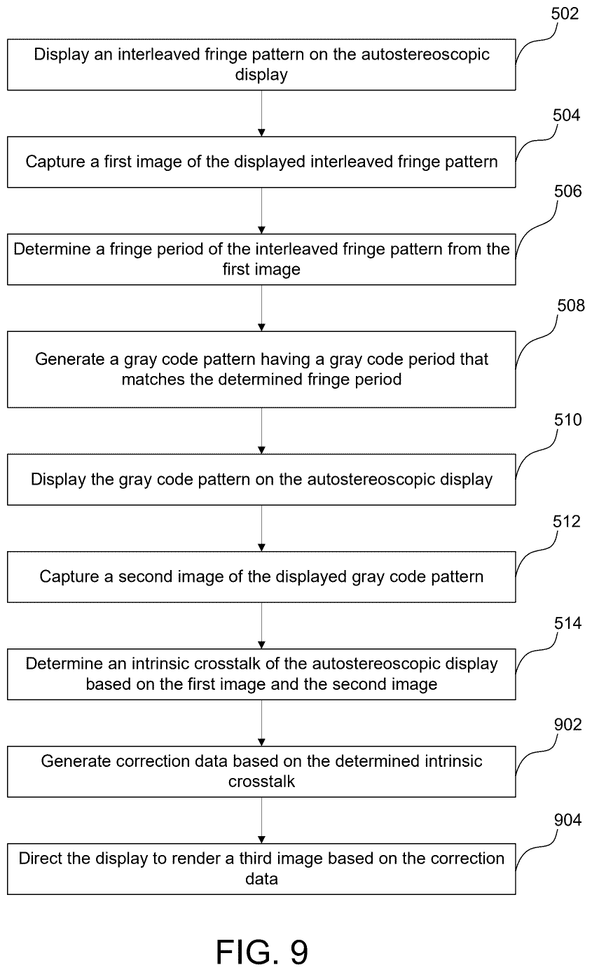

FIG. 9 is a flow chart illustrating another example method for characterizing veiling glare-corrected crosstalk for a 3D display system in accordance with at least one embodiment of the present disclosure. The example method of FIG. 9 extends the method described in FIG. 5 by applying characterization results to optimize the display device. The method includes generating correction data based on the determined intrinsic crosstalk at block 902. In some examples, the correction data includes compensation coefficients that mathematically correct for the crosstalk. For example, the correction data can take the form of an inverse crosstalk matrix or a lookup table (LUT) that specifies the necessary intensity adjustments to pre-compensate for the measured leakage. The method also includes directing the display to render a third image based on the correction data at block 904. This can include applying the correction data to an image rendering pipeline of the autostereoscopic display to compensate for the intrinsic crosstalk. During real-time operation, the rendering pipeline uses the LUT to modify the original image data before it is sent to the panel, effectively pre-distorting the image to cancel out the optical crosstalk and improve the perceived 3D quality for the viewer.

It will be appreciated that, in various implementations, the method of FIG. 9 can be repeated for multiple views, including a left eye view, a right eye view, different viewing orientations relative to the display (e.g., normal to the display and off-axis), and so forth. In such implementations, a characterization of crosstalk in the display can be determined for each of the different views. In these implementations, different correction coefficients can be determined for each distinct view. For example, where viewer tracking uses a camera to detect the pose of the viewer relative to the display, the correction coefficients corresponding to that view can be applied to correct for crosstalk.

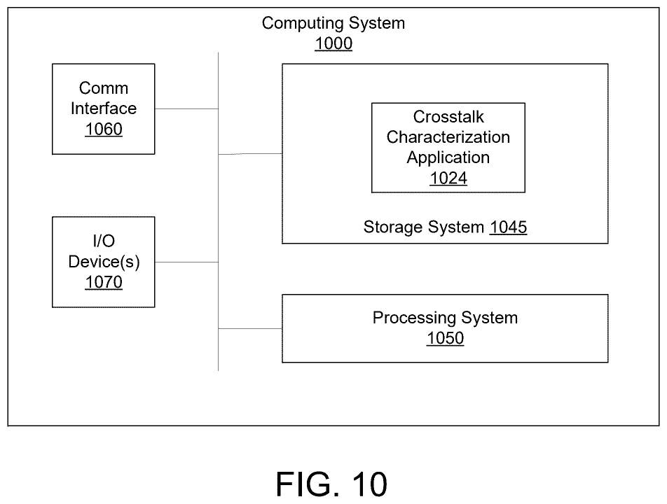

FIG. 10 illustrates a computing system to determine crosstalk associated with a display according to an implementation. Computing system 1000 is representative of any computing system or systems with which the various operational architectures, processes, scenarios, and sequences disclosed herein can be implemented to determine crosstalk associated with a display. Computing system 1000 may represent a server, a laptop, a tablet, or another computing device. Computing system 1000 can include multiple computing devices in some examples. Computing system 1000 includes storage system 1045, processing system 1050, communication interface 1060, and input/output (I/O) device(s) 1070. Processing system 1050 is operatively linked to communication interface 1060, I/O device(s) 1070, and storage system 1045. In some implementations, communication interface 1060 and/or I/O device(s) 1070 may be communicatively linked to storage system 1045. Computing system 1000 may further include other components, such as a battery and enclosure, that are not shown for clarity.

Communication interface 1060 comprises components that communicate over communication links, such as network cards, ports, radio frequency, processing circuitry and software, or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format, including combinations thereof. Communication interface 1060 may be configured to communicate with external devices, such as servers, user devices, or some other computing device. In some examples, communication interface 1060 can communicate with a display to request content to be displayed on the display. For example, communication interface 1060 can request that first content be displayed for a user's right eye and that second content be displayed for a user's left eye. In some examples, communication interface 1060 can further communicate with one or more cameras that can capture the display (act as simulated user eyes).

I/O device(s) 1070 may include computer peripherals that facilitate the interaction between the user and computing system 1000. Examples of I/O device(s) 1070 may include keyboards, mice, trackpads, monitors, displays, printers, cameras, microphones, external storage devices, and the like. In some implementations, I/O device(s) 1070 can include one or more cameras that act as a simulated user viewing a 3D display.

Processing system 1050 comprises microprocessor circuitry (e.g., at least one processor) and other circuitry that retrieves and executes operating software from storage system 1045. Storage system 1045 may include volatile and nonvolatile, removable, and non-removable media implemented in any method or technology for information storage, such as computer-readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 1050 is typically mounted on a circuit board that may hold the storage system. The operating software of storage system 1045 comprises computer programs, firmware, or another form of machine-readable program instructions. The operating software of storage system 1045 comprises a crosstalk characterization application 1024. The operating software on storage system 1045 may further include an operating system, utilities, drivers, network interfaces, applications, or some other type of software.

In at least one implementation, the crosstalk characterization application 1024 directs processing system 1050 to identify a first image of a display presenting a fringe pattern on the display, generate a gray code pattern having a same period as the fringe pattern, identify a second image of the display presenting the gray code pattern on the display, and determine an intrinsic crosstalk for the display is determined based on the first image and the second image. The crosstalk characterization application 1024 may also direct the processing system 1050 to carry out the operations set forth in FIGS. 5-9.

The embodiments described herein provide a particular technological improvement over conventional display calibration systems. The disclosed techniques are directed to a specific, practical application that solves a technical problem rooted in the physics of optical measurement systems. Conventional systems suffer from a technical flaw wherein a static veiling glare correction pattern (e.g., a chessboard) is inadequate for accurately correcting measurements across a range of test patterns (e.g., fringe patterns with varying periods), leading to inconsistent and unreliable intrinsic crosstalk values. The present technical solution overcomes this problem through a specific, unconventional sequence of steps that are inextricably tied to the physical hardware of the calibration system. By electronically analyzing a captured image of a first test pattern to determine its specific spatial characteristics, generating a second, custom correction pattern with matching spatial characteristics, and physically displaying and capturing this matched pattern, the system improves its functionality as a measurement tool. This process yields a more accurate, repeatable, and reliable characterization of the display's intrinsic crosstalk. The tangible and concrete result is a set of improved correction data that, when applied to the display's rendering pipeline, directly improves the functioning of the autostereoscopic display itself by producing a higher-quality, more visually comfortable three-dimensional image for the viewer.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
identifying a first image of a display presenting a fringe pattern on the display;
generating a gray code pattern having a same period as the fringe pattern;
identifying a second image of the display presenting the gray code pattern on the display; and
determining an intrinsic crosstalk for the display based on the first image and the second image.

2. The method of claim 1, wherein the display is an autostereoscopic display; and wherein the fringe pattern is included in an interleaved image presented on the autostereoscopic display.

3. The method of claim 2, wherein the gray code pattern is included in a non-interleaved image presented on the autostereoscopic display.

4. The method of claim 1, wherein determining a fringe period of the fringe pattern from the first image includes:
determining an orientation of the fringe pattern; and
wherein generating the gray code pattern having the same period as the fringe pattern includes:
generating the gray code pattern having a same orientation as the fringe pattern.

5. The method of claim 1, wherein the intrinsic crosstalk is determined based on a ratio of a first contrast of the first image to a second contrast of the second image.

6. The method of claim 1 further comprising normalizing the first image and the second image using a full-black reference image and a full-bright reference image prior to determining the intrinsic crosstalk.

7. The method of claim 1 further comprising:
generating correction data based on the intrinsic crosstalk; and
directing the display to render a third image based on the correction data.

8. A system for characterizing crosstalk in an autostereoscopic display, the system comprising:
at least one processor;
a computer-readable storage medium operatively coupled to the at least one processor; and
program instructions stored on the computer-readable storage medium that, when executed by the at least one processor, direct the system to perform operations comprising:
identifying a first image of a display presenting a fringe pattern on the display;
generating a gray code pattern having a same period as the fringe pattern;
identifying a second image of the display presenting the gray code pattern on the display; and
determining an intrinsic crosstalk for the display based on the first image and the second image.

9. The system of claim 8, wherein the display is an autostereoscopic display; and wherein the fringe pattern is included in an interleaved image presented on the autostereoscopic display.

10. The system of claim 9, wherein the gray code pattern is included in a non-interleaved image presented on the autostereoscopic display.

11. The system of claim 8, wherein determining a fringe period of the fringe pattern from the first image includes:
determining an orientation of the fringe pattern; and
wherein generating the gray code pattern having the same period as the fringe pattern includes:
generating the gray code pattern having a same orientation as the fringe pattern.

12. The system of claim 8, wherein the intrinsic crosstalk is determined based on a ratio of a first contrast of the first image to a second contrast of the second image.

13. The system of claim 8, wherein the operations include:
normalizing the first image and the second image using a full-black reference image and a full-bright reference image prior to determining the intrinsic crosstalk.

14. The system of claim 8, where the operations include:
generating correction data based on the intrinsic crosstalk; and
directing the display to render a third image based on the correction data.

15. A non-transitory computer-readable medium storing instructions that, when executed by a processor, cause the processor to perform operations comprising:
identifying a first image of a display presenting a fringe pattern on the display;
generating a gray code pattern having a same period as the fringe pattern;
identifying a second image of the display presenting the gray code pattern on the display; and
determining an intrinsic crosstalk for the display based on the first image and the second image.

16. The computer-readable medium of claim 15, wherein the display is an autostereoscopic display; and wherein the fringe pattern is included in an interleaved image presented on the autostereoscopic display.

17. The computer-readable medium of claim 16, wherein the gray code pattern is included in a non-interleaved image presented on the autostereoscopic display.

18. The computer-readable medium of claim 15, wherein determining a fringe period of the fringe pattern from the first image includes:
determining an orientation of the fringe pattern; and
wherein generating the gray code pattern having the same period as the fringe pattern includes:
generating the gray code pattern having a same orientation as the fringe pattern.

19. The computer-readable medium of claim 15, wherein the intrinsic crosstalk is determined based on a ratio of a first contrast of the first image to a second contrast of the second image.

20. The computer-readable medium of claim 15, where the operations include:
generating correction data based on the intrinsic crosstalk; and
directing the display to render a third image based on the correction data.
